(19) United States
(12) Patent Application Publication
(10) Pub. No.: US 2008/0127803 A1
(43) Pub. Date: Jun. 5, 2008

(54) Electronic Percussion Instrument Structure and Pad Structure Thereof

(76) Inventor: tzu-chen Liu, Keelung City (TW)

Correspondence Address: LAW OFFICES OF LAI AND ASSOCIATES, P.C., 5800 RANCHESTER STE 200, HOUSTON, TX, 77036, US

(21) Appl. No.: 11/565,581

(22) Filed: Nov. 30, 2006

(51) Int. Cl. G10D 13/02

(52) U.S. Cl. 84/411 R

(57) ABSTRACT

An electronic percussion instrument structure and pad structure thereof are disclosed. The electronic percussion instrument structure includes a plurality of structural panels and a plurality of pads disposed on the structural panels to receive percussions struck by sticks. The plurality of structural panels is arranged at different heights respectively to form a stair structure that improves percussion efficiency.

### FIELD OF THE INVENTION

The present invention generally relates to an electronic percussion instrument structure and pad structure thereof, and more specifically relates to the electronic percussion instrument structure by utilizing a stair structure composed of a plurality of structural panels to achieve the goal of smooth percussion.

### BACKGROUND OF THE INVENTION

As technology is developed gradually, the appearance of an electronic percussion instrument such as electronic drum may simulate real drums. Referring to FIG. 1, a front view shows an operating panel 11 of a conventional electronic percussion instrument 10. The operating panel 11 is provided with a plurality of pads 12 that comprise nine pads (percussion surfaces) 12a through 12i and a control interface 13 (dotted line) for controlling the pads 12. However, the pads 12 are usually arranged too close to each other that produce interference phenomenon and resonances. The tone quality generated by striking the pads 12 may also be influenced. Moreover, the pads 12 disposed on the operating panel 11 are almost at the same height without any relief as shown in FIG. 2 for a side view showing the pads struck by sticks 20. When a user end (not shown) would like to perform interlacing percussion, the sticks 20 may knock against each other because there is no elevation difference for the pads 12. Furthermore, the pads 12 do not have any inclination either and consequently the user end must comply with the pad arrangement, and more forces are applied on the sticks 20 while striking the pads 12. A larger included angle θ between the pads 12 and the sticks 20 then is formed to reduce percussion efficiency, and ergonomics may not be satisfied.

Another drawback is that the conventional electronic percussion instrument often uses integrated circuits (ICs) to provide musical sounds with MIDI (Musical Instrument Digital Interface) files that may not provide better sound effects to the user end.

To overcome the foregoing shortcomings, the inventor of the present invention based on years of experience in the related field conducting extensive research and experiments, invents an electronic percussion instrument structure and pad structure thereof as a method or a basis for achieving the aforementioned object.

### SUMMARY OF THE INVENTION

Therefore, it is a primary object of the present invention to provide an electronic percussion instrument structure by using a stair structure composed of a plurality of structural panels to achieve the goal of smooth percussion and reduce the user end's workloads.

To achieve the foregoing object, the electronic percussion instrument structure comprises a plurality of structural panels and a plurality of pads disposed on the plurality of structural panels to receive percussions struck by sticks, wherein the plurality of structural panels are arranged at different heights respectively to form a stair structure. The plurality of structural panels has inclinations that are toward the user end so that the user end does not need to comply with the panels. The electronic percussion instrument structure is an electronic drum, and the plurality of structural panels is made by integrated molding and composed of a plastic material. The electronic percussion instrument structure further has two speakers disposed on the plurality of structural panels to broadcast musical sounds. The plurality of pads is made by integrated molding and composed of elastic materials as rubbers. Moreover, the electronic percussion instrument structure further has detection units mounted under the pads to detect the percussion intensity when the pads are struck, and has a tone generation unit for generating tones with respect to the detected percussion intensity, and has an acoustic processing unit for applying and modifying one or more effects to the tones generated by the tone generation unit. These pads have appropriate distances between therein to prevent interference with each other and resonances. A controlling area is disposed to the stair structure, and is composed of a plurality of multi-function keys and at least one display to control the musical sounds. By using the stair structure, the percussion efficiency is improved, and ergonomics can be satisfied.

Another object of the present invention is to provide a pad structure that is applied in an electronic percussion instrument. The pad structure is disposed on a structural panel of the electronic percussion instrument, and comprises a pad member, a pad plate disposed under the pad member and supported by a plurality of cylinders, and a plurality of absorbers disposed on the cylinders to absorb impacts delivered from the pad member to the pad plate to prevent resonances from influencing the structural panel so as to improve tone quality.

To make it easier for our examiner to understand the object of the invention, its innovative features and performance, a detailed description and technical characteristics of the present invention are described together with the drawings as follows.

### BRIEF DESCRIPTION OF THE DRAWINGS

FIG. 1 is a front view of an operating panel of a conventional electronic percussion instrument;

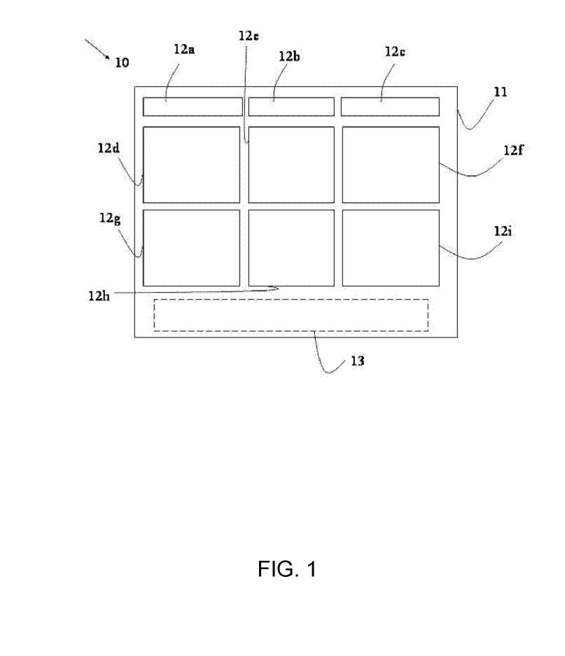

FIG. 2 is a side view of an operating panel of a conventional electronic percussion instrument according to FIG. 1;

FIG. 3 is an elevation view of an electronic percussion instrument structure according to an embodiment of the invention;

FIG. 4 is a plan view of an electronic percussion instrument structure according to a preferred embodiment of the invention;

FIG. 5 is a pictorial drawing of an electronic percussion instrument structure according to a preferred embodiment of the invention;

FIG. 6 is a side view of an electronic percussion instrument structure according to a preferred embodiment of the invention;

FIG. 7 is a schematic diagram of a controlling area of an electronic percussion instrument structure according to a preferred embodiment of the invention;

FIG. 8 is a rear view from different visual angles of an electronic percussion instrument structure of the invention; and

FIG. 9 is a cross-sectional drawing of a pad structure of the present invention.

### DETAILED DESCRIPTION OF THE PREFERRED EMBODIMENTS

Referring to the related figures for the electronic percussion instrument structure and the pad structure according to a preferred embodiment of the present invention, wherein the same elements are described by the same reference numerals.

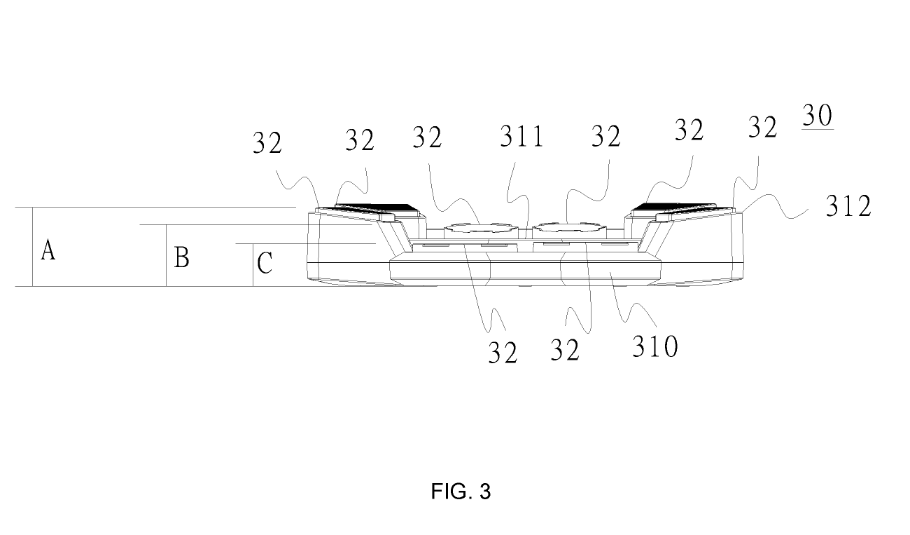

Referring to FIG. 3 for the elevation view of an electronic percussion instrument structure according to an embodiment of the invention, the electronic percussion instrument structure 30 comprises a plurality of structural panels 31 and a plurality of pads 32 (percussion surfaces) disposed on the plurality of structural panels to receive percussions struck by sticks. The characteristic of the electronic percussion instrument structure 30 is that the plurality of structural panels 31 are arranged at different heights respectively to form a stair structure as a ladder shaped, thereby increasing the percussion efficiency. The plurality of structural panels 31 can be divided into a first structural panel 310, a second structural panel 311, a third structural panel 312. In the embodiment, the height of the third structural panel 312 is A, and the height of the second structural panel 311 is B, and the height of the first structural panel 310 is C. A is higher than B and C, and B is higher than C so as to form the complete stair structure for the electronic percussion instrument.

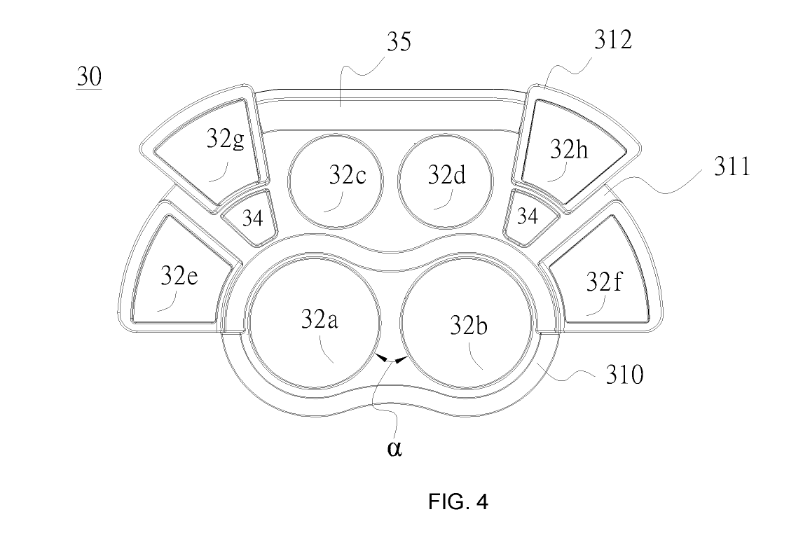

Referring to FIG. 4 for the plan view of an electronic percussion instrument structure according to a preferred embodiment of the invention, the pads 32 are usually composed of four circular pads 32a-32d and four fan-shaped pads 32e-32h. It should be noted that the pads 32 are not limited to eight pads, and the amount of the pads 32 can be increased upon demands of the user end. The pads 32 are made by integrated molding and composed of elastic materials as rubbers. The pads 32 have appropriate distances α between therein to prevent resonances. The plurality of structural panels is made by integrated molding and composed of a plastic material. The electronic percussion instrument structure is preferably an electronic drum. Two speakers 34 are disposed onto the plurality of structural panels to broadcast musical sounds, and a controlling area 35 is disposed to the electronic percussion instrument structure 30, and is composed of a plurality of multifunction keys and at least one display to control the musical sounds.

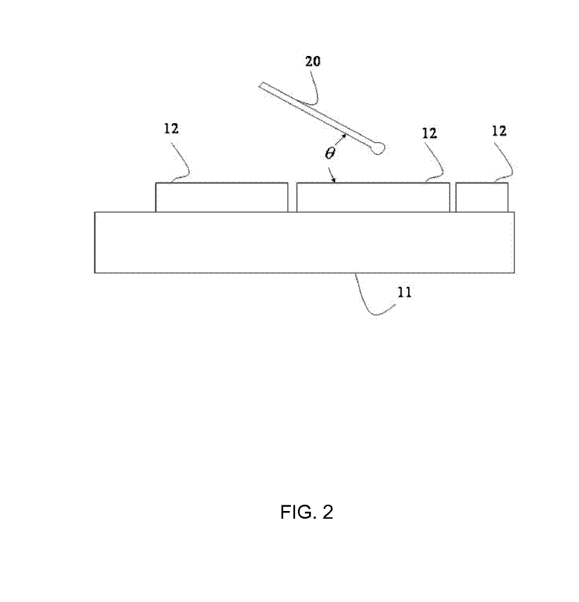

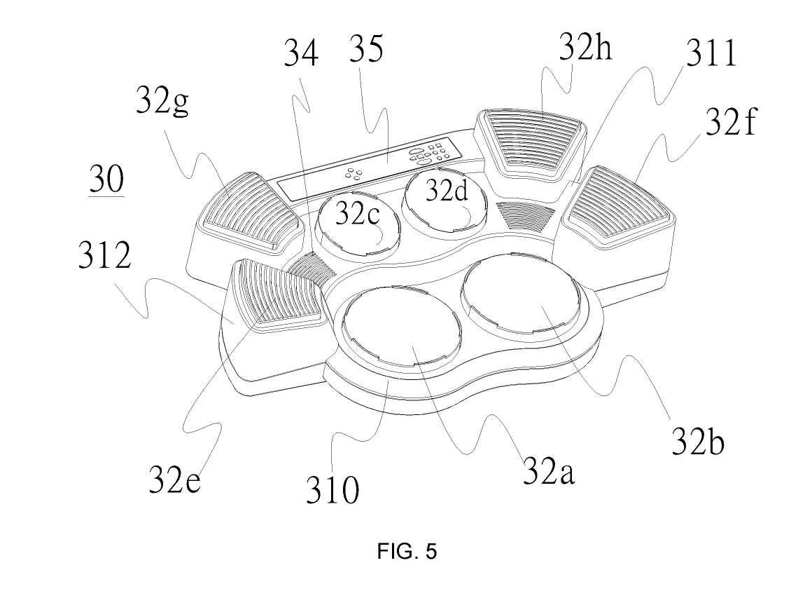

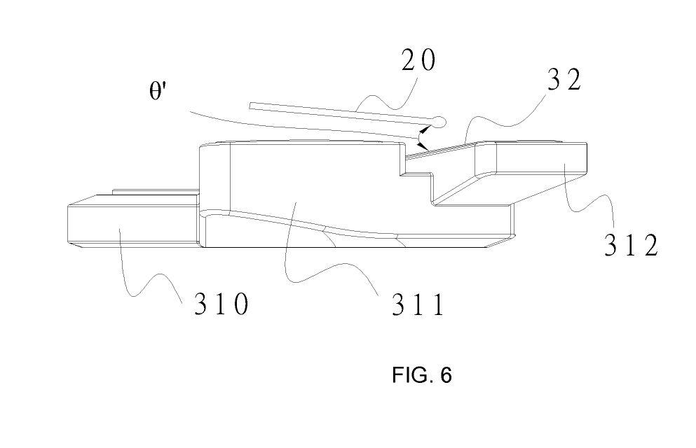

Referring to FIG. 5 for the pictorial drawing of an electronic percussion instrument structure according to a preferred embodiment of the invention, the plurality of pads 32a-h disposed on the electronic percussion instrument structure 30 has inclinations that are toward a user end to meet ergonomics. Referring to FIG. 6 for the side view of an electronic percussion instrument structure according to a preferred embodiment of the invention is illustrated. When the sticks 20 are utilized to strike the pads 32 of the structural panels 31, the user end does not need to apply more forces on the sticks 20 due to the stair structure, thereby reducing the workload of the user end. A smaller included angle θ′ between the sticks 20 and the pads 32 then is formed after comparing with FIG. 2. Moreover, when the user end performs interlacing percussion, the sticks 20 may not knock each other so that percussion efficiency is therefore improved.

Moreover, a plurality of detection units (not shown in the figure) is mounted under the pads 32 to detect the percussion intensity when the pads 32 are struck. A tone generation unit (not shown in the figure) is disposed in the electronic percussion instrument structure 30 to generate tones with respect to the detected percussion intensity. An acoustic processing unit (not shown in the figure) is also disposed in the electronic percussion instrument structure 30 to apply and modify one or more effects on tones generated by the tone generation unit. The acoustic processing unit is preferably a DSP (digital signal processor).

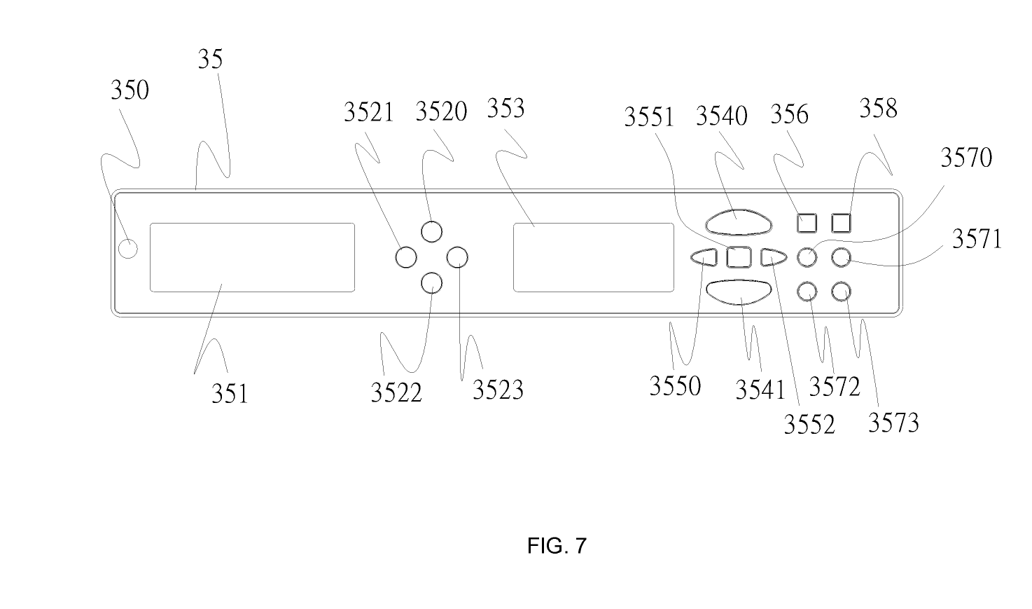

Referring to FIG. 7 for a schematic diagram of a controlling area 35 of an electronic percussion instrument structure according to a preferred embodiment of the invention is illustrated. The controlling area 35 includes a power indicator 350 for showing power status, two display devices 351 and 353 for showing various results selected by the user end, a plurality of tone selection buttons 3520 through 3523, two volume adjustment keys 3540 and 3541, a rewinding button 3550, a play/pause button 3551, a forward button 3552, a stop button 356, a repeat button 3570 for repeatedly playing the music sounds, an A-B button 3571 for circling the section, a deleting button 3572 for deleting music files, a reset button 3573 for resetting the system and a recording button 358 for recording the music sounds.

The function of the controlling area 35 further includes effect adjustment, pad indication, playback function, parameter/instruction inputs, page right/left (RL), decrease (DEC)/increase (INC), etc. The aforesaid functions can be processed by the acoustic processing unit. The tone selection buttons 3520-3523 are composed of the top and bottom style selection buttons and the left and right patch selection buttons. The display devices 351 and 353 of the controlling area 35 are preferably LCDs (liquid crystal display) to show concert programs for example and other results. Furthermore, a storage unit (not shown in the figure) is disposed in the electronic percussion instrument structure 30 to store data with respect to the musical sounds or images or programs, and is preferably a memory such as a flash memory, a memory card, etc. Alternatively, the memory, a SD (secure digital) card for example, can be directly inserted into the electronic percussion instrument structure 30 through a slot. The electronic percussion instrument structure can connect with a headset (not shown in the figure) through relative interface ports. The user end can use the headset to listen tones or musical sounds. The electronic percussion instrument structure 30 further has a MP3 (Motion Picture Experts Group-1 audio layer 3) compression scheme for directly composing musical sounds, not MIDI only The electronic percussion instrument structure 30 also has MP4 function to achieve the goal of directly broadcasting so as to teach learners. Additionally, the electronic percussion instrument structure 30 can be equipped with an external device (not shown in the figure) to capture the images with respect to percussion state for tutoring or interaction education. The images can be stored in the SD card inserted into the external device. The external device is preferably a video capture device.

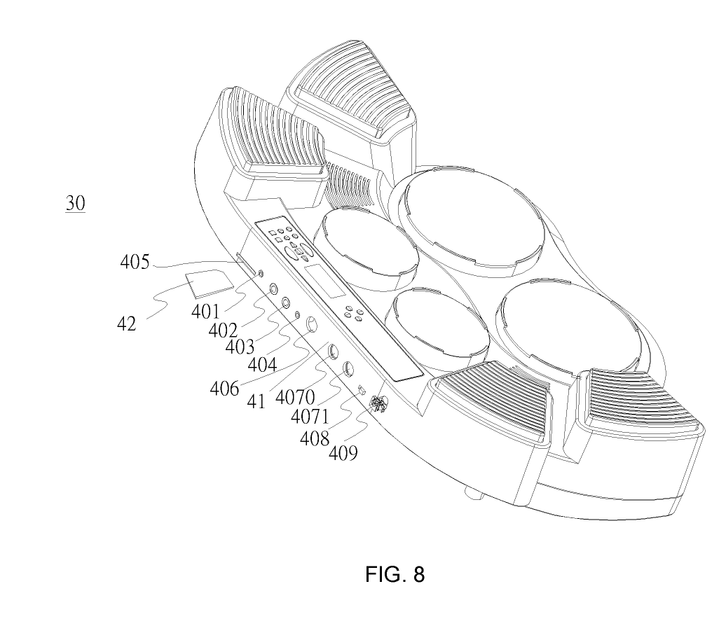

Referring to FIG. 8 for the rear view from different visual angles of an electronic percussion instrument structure of the invention, the rear 41 of the structure 30 further has a plurality of ports that can be connected by different peripheries for transmission. These ports includes a headset-in jack 401 for inserting earphones, left/right outputs 402, 403 for mixers or amplifiers, a line-in jack 404 for a microphone, a slot 405 for inserting a flash memory such as a SD card 42, a volume output 406 for outputting volume, MIDI in/out ports 4070, 4071 for connecting cables, a power switch 408 for turning on/off the electronic percussion instrument and a power supply port 409 for direct current supply

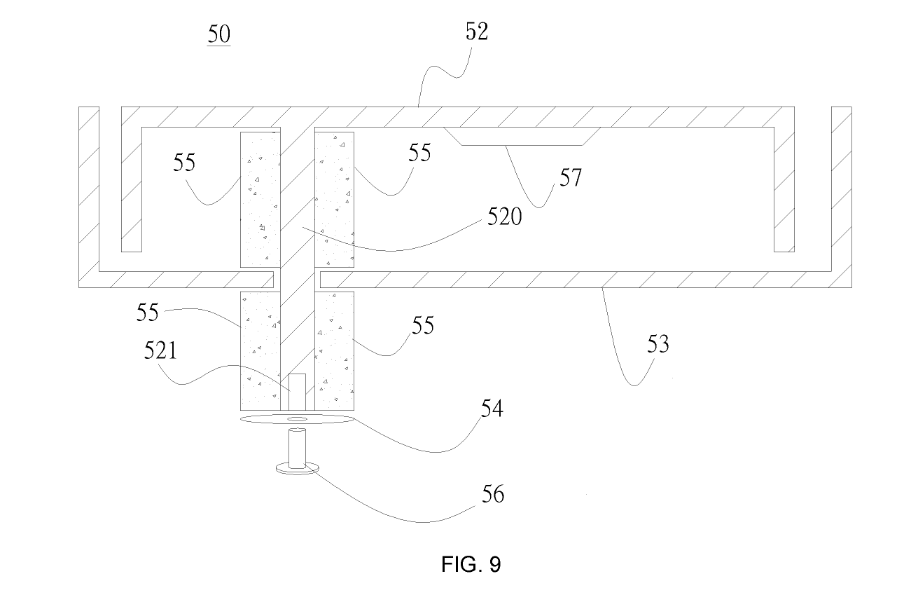

Referring to FIG. 9 for a cross-sectional drawing of a pad structure of the present invention is illustrated. The pad structure 50 is applied to an electronic percussion instrument, and is disposed on a structural panel 51 of the electronic percussion instrument. The pad structure 50 comprises a pad member 52, a pad plate 53 disposed under the pad member 52 and supported by at least one cylinder 520, and at least one absorber 55 disposed on the cylinder 520 to absorb impacts delivered from the pad member 52 to the pad plate 53 to prevent resonances from influencing the structural panel so as to improve tone quality and eliminate interference. The pad member 52 is made by an elastic material as a rubber to receive the impacts generated by percussions. The pad plate 53 is made by plastic injection molding, and the absorber 55 is preferably foam for absorbing and isolating the impacts to efficiently prevent the resonances. At least one locking member 56, a screw for example, penetrates a spacer 54 disposed under the absorber 55 to enter a hole 521 of the cylinder 520 so as to fasten the absorber 55. A detection unit 57, such as a buzzer, is disposed under the pad plate 53 to detect the striking intensity.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An electronic percussion instrument structure comprising:
a plurality of structural panels; and
a plurality of pads disposed on the plurality of structural panels to receive percussions struck by sticks,
wherein the plurality of structural panels is arranged at different heights respectively to form a stair structure.

2. The electronic percussion instrument structure of claim 1, wherein the plurality of structural panels includes a first structural panel, a second structural panel and a third structural panel, and the third structural panel is higher than the second structural panel, and the second structural panel is higher than the first structural panel.

3. The electronic percussion instrument structure of claim 1, wherein the electronic percussion instrument structure further includes a MP3 function for directly composing musical sounds.

4. The electronic percussion instrument structure of claim 1, wherein the plurality of structural panels is made by integrated molding and composed of a plastic material.

5. The electronic percussion instrument structure of claim 1, wherein the electronic percussion instrument structure is an electronic drum.

6. The electronic percussion instrument structure of claim 1, wherein the electronic percussion instrument structure further has at least one speaker disposed onto the plurality of structural panels to broadcast musical sounds.

7. The electronic percussion instrument structure of claim 1, wherein the plurality of pads is made by integrated molding and composed of elastic materials as rubbers.

8. The electronic percussion instrument structure of claim 1, wherein the electronic percussion instrument structure further has detection units that are mounted under the pads to detect the percussion intensity when the pads are struck.

9. The electronic percussion instrument structure of claim 1, wherein the pads have appropriate distances between therein to prevent interference with each other and resonances.

10. The electronic percussion instrument structure of claim 1, wherein the electronic percussion instrument structure further has a tone generation unit for generating tones with respect to the detected percussion intensity.

11. The electronic percussion instrument structure of claim 1, wherein the electronic percussion instrument structure further has an acoustic processing unit for applying and modifying one or more effects to the tones generated by the tone generation unit.

12. The electronic percussion instrument structure of claim 1, wherein the electronic percussion instrument structure further has a controlling area disposed to the stair structure, and the controlling area is composed of a plurality of multi-function keys and at least one display to control the musical sounds.

13. The electronic percussion instrument structure of claim 1, wherein the electronic percussion instrument structure further has a storage unit for storing data with respect to the musical sounds, images or programs, and the storage unit is a memory.

14. The electronic percussion instrument structure of claim 13, wherein the electronic percussion instrument structure is equipped with an external device to capture the images with respect to percussion state for tutoring or interaction education.

15. The electronic percussion instrument structure of claim 14, wherein the external device is a video capture device.

16. A pad structure, applicable for an electronic percussion instrument and disposed on a structural panel of the electronic percussion instrument, the pad structure comprising:
a pad member;
a pad plate disposed under the pad member, and having at least one cylinder to support the pad plate; and
at least one absorber disposed on the cylinder to absorb impacts delivered from the pad member to the pad plate to prevent the resonances from influencing the structural panel so as to improve tone quality and eliminate interference.

17. The pad structure of claim 16, wherein the pad member is made by an elastic material as a rubber to receive the impacts generated by percussions.

18. The pad structure of claim 16, wherein the absorber is foam for absorbing and isolating the impacts.

19. The pad structure of claim 16, wherein the pad structure further utilizes at least one locking member to fasten the absorber.

20. The pad structure of claim 16, wherein the pad structure further has a detection unit disposed under the pad plate to detect the striking intensity.
